(19) United States
(12) Patent Application Publication
(10) Pub. No.: US 2005/0203212 A1
(43) Pub. Date: Sep. 15, 2005

(54) Nano-particulate tin coated products

(75) Inventors: Paul Andrew Cusack, Iver Heath (GB); David Ronald Clack, Mortimer Common (GB)

Correspondence Address: LAHIVE & COCKFIELD, LLP., 28 STATE STREET, BOSTON, MA, 02109, US

(73) Assignee: ITRI LIMITED, Albans, Hertfordshire (GB)

(21) Appl. No.: 10/515,193

(22) PCT Filed: Apr. 14, 2003
(86) PCT No.: PCT/GB03/01561

§ 371 Date: Nov. 19, 2004

(30) Foreign Application Priority Data
May 22, 2002 (GB) 0211780.2

(51) Int. Cl. C08K 9/10; C08K 3/10

(52) U.S. Cl. 523/210; 524/434

(57) ABSTRACT

A process for the preparation of an inorganic filler material coated with a nano-particulate tin compound which comprises forming a slurry of the filler material in an aqueous colloidal suspension of a tin compound, whereby the tin compound is directly precipitated from the colloidal suspension onto the surface of the filler, separating the inorganic filler from the colloidal suspension and, optionally, heating the coated filler to convert the hydrated tin compound to the anhydrous form. A fire retardant material comprises a particulate inorganic material coated with a nano-particulate tin product in an amount of from 1 to 100% by weight, based on the weight of the inorganic filler.

The present invention relates to the preparation of nano-particulate tin-containing species, their deposition on to particulate substrates, and the application of the resulting products as fire-retardant fillers, catalysts, ion exchange systems and electroconductive powders and films.

Tin(IV) oxide and related inorganic tin compounds are known as non-toxic flame retardants and smoke suppressants for a wide range of organic polymers. For example, tin compounds such as zinc hydroxystannate (ZHS), zinc stannate (ZS) and tin(IV) oxide (SnO₂) have been shown to exhibit good flame-retardant and smoke-suppressant properties in halogen-containing polymer formulations such as PVC and polychloroprene, and in other plastics and rubbers, particularly those which contain organic chlorine or bromine compounds as additive-type flame retardants. The non-toxic nature of the inorganic tin compounds, combined with their dual flame-retardant and smoke-suppressant activity, has generated considerable interest in their use as alternatives to antimony trioxide in halogenated polymer systems.

It has been found that the conditions used to prepare these tin compounds can be modified in such a way that the resulting powdered products have greatly reduced particle sizes compared with powders produced by conventional methods. Furthermore, it has been shown that such ‘ultrafine’ powders have improved flame retardancy and smoke suppression compared with standard powders, when incorporated into polymeric substrates. Thus WO 90/09962 discloses methods for producing sub-micrometre scale ZHS and ZS powders, and their application as fire-retardant additives for organic polymers.

It has also been disclosed in EP-B1-0833862 that the use of filler powders comprising a particulate inorganic filler material, the particles of which are coated with the ultrafine ZHS/ZS particles described in WO 90/09962, gives improved flame retardancy and smoke suppression as compared with the use of the fillers themselves, or with simple mixtures of the two components (filler and tin compound). Lower levels of the coated fillers, compared with the corresponding uncoated grades, are required for a given fire-retardant performance, and this reduction in filler loading leads to better polymer processing and improved physical and mechanical properties.

Processes for preparing stable aqueous colloidal sols of tin(IV) oxide and related inorganic tin compounds, such as tin(IV) phosphate, tin(IV) borate and tin(IV) tartrate, have been disclosed in EP-B1-0896649. The colloidal products prepared using this process, and which contain nanometre-scale particles, are used to impregnate cellulosic materials, such as paper, card, cardboard or pulp. These colloidal tin additives represent an improvement in dispersion of another order of magnitude compared with the ultrafine powders discussed above.

It has now been found, in accordance with the present invention, that it is possible to coat inorganic particulate substrates with nanometre-scale particles of tin compounds using, as the starting material, the aqueous colloidal suspensions as described above. Accordingly, inorganic particulate fillers, such as alumina trilydrate (ATH), magnesium hydroxide, calcium carbonate, magnesium carbonate, zinc borate, silica, talc, anhydrous alumina, sodium bentonite, nanoclays (such as those produced as the reaction product of a smectite-type clay and a mixture of a quaternary ammonium compound and a chain transfer agent, or those produced from natural or synthetic layered silicates based on montmorillonite together with a suitable organic interaction agent usually a quaternary ammonium compound), and naturally occurring mixtures of magnesium calcium carbonate (Huntite) and hydrated basic magnesium carbonate (Hydromagnesite), may be coated using such a process.

According to the present invention there is provided a process for the preparation of an inorganic material which comprises a particulate inorganic filler selected from alumina trihydrate, magnesium hydroxide, calcium carbonate, magnesium carbonate, zinc borate, silica, talc, anhydrous alumina, sodium bentonite, nanoclays, magnesium calcium carbonate, hydrated basic magnesium carbonate, or mixtures thereof coated with nano-particulate tin compounds, which process comprises the steps of:
(i) forming a slurry of the said particulate inorganic filler in an aqueous colloidal suspension of a tin compound, whereby the tin compound is directly precipitated from the colloidal suspension onto the surface of the said filler,
(ii) separating the said inorganic filler from the colloidal suspension, either with or without the adjustment of the pH of the slurry prior to separation,
(iii) optionally, heating the filler coated with the nano-particulate tin compound, in order to convert the hydrated tin compound to an anhydrous form.

In step (i) of the process of the present invention the aqueous colloidal suspension of the tin compound may contain other chemical compounds such as an inorganic or carboxylic acid, or a soluble metal salt.

The inorganic or carboxylic acid which may optionally be used in step (i) of the process of the present invention may be phosphoric acid, boric acid, tartaric acid or citric acid. The soluble metal salt which may optionally be used in step (i) of the process of the present invention may be a salt of zinc, iron, cobalt, nickel or copper.

In step (ii) of the process of the present invention the pH of the colloidal suspension may be adjusted by the addition of an acid, such as nitric acid, or a base such as ammonia.

The coated inorganic particulate filler produced by the present invention may find application where it is desired to apply a coating of a tin compound having a high surface area on to the surface of an inorganic substrate. Thus, for example, the nano-particulate coated fillers of the present invention may be used in applications such as fire-retardant fillers for polymers, heterogeneous catalysts, ion exchange systems and electroconductive powders and films.

The present invention also provides a polymer composition comprising a polymer and a fire-retardant coated inorganic particulate filler produced by the process as defined above. Suitably, the coated particulate inorganic fire-retardant filler will be present in the polymer composition in an amount from 5 to 400% by weight, based on the weight of polymeric material, preferably 20 to 200% by weight on the same basis. Further, the fire-retardant coated filler itself preferably contains the nano-particulate tin compound in an amount from 1 to 100%, preferably 2 to 50% by weight, based on the weight of the inorganic filler.

The inorganic fillers which may be used in the present invention include alumina trihydrate (ATH), magnesium hydroxide, calcium carbonate, magnesium carbonate, zinc borate, silica, talc, anhydrous alumina, sodium bentonite, nanoclays (such as those produced as the reaction product of a smectite-type clay and a mixture of a quaternary ammonium compound and a chain transfer agent, or those produced from natural or synthetic layered silicates based on montmorillonite together with a suitable organic interaction agent usually a quaternary ammonium compound), and naturally occurring mixtures of magnesium calcium carbonate (Huntite) and hydrated basic magnesium carbonate (Hydromagnesite). Suitably, the particles of the inorganic filler will have an average particle size in the range of from 0.01 to 100 micrometres, preferably from 0.1 to 20 micrometres.

The polymer component of the composition may be any of a wide variety of materials, e.g. thermoplastic, thermosetting or elastomeric, and may include halogen-containing and halogen-free formulations. The polymers may be in the form of block, sheet, foam, fibre or in compounded form, e.g. in a paint or similar coating composition.

In order that the invention may be further understood, the following Examples are given by way of illustration only.

### EXAMPLE 1

Anhydrous tin(IV) chloride (86 g) was added cautiously to distilled water (1 litre) and the resulting solution was adjusted to pH 9 using aqueous ammonia (s.g. 0.88). The slurry was then adjusted to pH 4 using dilute (1:1) nitric acid and the resulting white precipitate of hydrous tin(IV) oxide was separated by centrifugation and washed with distilled water until free of chloride ion (negative aqueous silver nitrate test). Aqueous ammonia (s.g. 0.88) was added to the washed precipitate until a pH of approximately 10 was reached, following which the slurry was heated to 60° C. and maintained at this temperature for 2 hours, thereby effecting its peptisation to form a clear colloidal sol of tin(IV) oxide. The sol was allowed to cool to room temperature and distilled water was added to make up the volume of the colloid to 1 litre. 40 ml of the resulting colloid (pH 10.4) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 17.9% Sn by weight.

### EXAMPLE 2

A ‘half-strength’ aqueous tin(IV) oxide colloid was prepared by adding 500 ml of distilled water to 500 ml of the colloid produced in Example 1. 40 ml of the resulting colloid (pH 10.3) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 11.0% Sn by weight.

### EXAMPLE 3

Anhydrous tin(IV) chloride (344 g) was added cautiously to distilled water (4 litres) and the resulting solution was adjusted to pH 9 using aqueous ammonia (s.g. 0.88). The slurry was then adjusted to pH 4 using dilute (1:1) nitric acid and the resulting white precipitate of hydrous tin(IV) oxide was separated by centrifugation and washed with distilled water until free of chloride ion (negative aqueous silver nitrate test). Aqueous ammonia (s.g. 0.88) was added to the washed precipitate until a pH of approximately 10 was reached, following which the slurry was heated to 60° C. and maintained at this temperature for 2 hours, thereby effecting its peptisation to form a clear colloidal sol of tin(IV) oxide. The sol was allowed to cool to room temperature and distilled water was added to make up the volume of the colloid to 4 litres. Magnesium hydroxide (500 g) was added to this colloid (pH 10.0) and the resulting slurry was stirred vigorously for 3 hours at room temperature. The resulting product was separated by centrifugation, washed with distilled water, and dried in air at 105° C. for 16 hours, to give a white powder which analysed as 19.5% Sn by weight.

### EXAMPLE 4

A colloidal suspension of tin(IV) phosphate was prepared by adding phosphoric acid (81 g of 85% by weight aqueous H₃PO₄) with stirring to a warm (65° C.) 1 litre solution containing sodium hydroxystannate (80 g). 40 ml of the resulting colloid (pH 3.8) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 15.3% Sn and 7.0% P by weight.

### EXAMPLE 5

A ‘half-strength’ aqueous tin(IV) phosphate colloid was prepared by adding 500 ml of distilled water to 500 ml of the colloid produced in Example 4. 40 ml of the resulting colloid (pH 4.0) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 8.2% Sn and 4.1% P by weight.

### EXAMPLE 6

A colloidal suspension of tin(IV) borate was prepared by adding boric acid (93 g) with stirring to a warm (65° C.) 1 litre solution containing sodium hydroxystannate (26.7 g). 40 ml of the resulting colloid (pH 6.6) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 7.0% Sn and 0.4% B by weight.

### EXAMPLE 7

A ‘half-strength’ aqueous tin(IV) borate colloid was prepared by adding 500 ml of distilled water to 500 ml of the colloid produced in Example 6. 40 ml of the resulting colloid (pH 7.2) were added to magnesium hydroxide (5 g) in a 50 ml screw-capped tube, and the tube was agitated on a mechanical shaker for 3 hours. The resulting product was separated by centrifugation, washed with distilled water, and dried in air at 105° C. for 2 hours, to give a white powder which analysed as 3.3% Sn and 0.1% B by weight.

### EXAMPLE 8

40 ml of a colloidal suspension of tin(IV) oxide, prepared as in Example 1, were added to 5 g of a proprietary mineral filler, ‘Ultracarb’ (ex-Microfine Minerals)—itself a mixture of Huntite (magnesium calcium carbonate) and Hydromagnesite (hydrated basic magnesium carbonate), in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 18.8% Sn by weight.

### EXAMPLE 9

40 ml of a colloidal suspension of tin(IV) oxide, prepared as in Example 1, were added to 5 g of calcium carbonate in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 18.3% Sn by weight.

### EXAMPLE 10

40 ml of a colloidal suspension of tin(IV) oxide, prepared as in Example 1, were added to 5 g of zinc borate in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 22.7% Sn by weight.

### EXAMPLE 11

40 ml of a colloidal suspension of tin(IV) phosphate, prepared as in Example 4, were added to 5 g of Ultracarb in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 15.1% Sn and 5.9% P by weight.

### EXAMPLE 12

40 ml of a colloidal suspension of tin(IV) phosphate, prepared as in Example 4, were added to 5 g of zinc borate—in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 18.4% Sn and 10.6% P by weight.

### EXAMPLE 13

40 ml of a colloidal suspension of tin(IV) oxide, prepared as in Example 1, were added to 5 g of standard grade alumina trihydrate (Martinal OL-104, ex-Martinswerk) in a 50 ml screw-capped tube. The pH of the resulting suspension was adjusted from 10.0 to 3.9 using dilute nitric acid and the resulting product was separated by centrifugation, washed with distilled water, and dried in air at 105° C. for 2 hours, to give a white powder which analysed as 21.1% Sn by weight.

### EXAMPLE 14

40 ml of a colloidal suspension of tin(IV) oxide, prepared as in Example 1, were added to 5 g of a thermally-stable grade alumina trihydrate (Martinal TS-601, ex-Martinswerk) in a 50 ml screw-capped tube. The pH of the resulting suspension was adjusted from 10.0 to 4.1 using dilute nitric acid and the resulting product was separated by centrifugation, washed with distilled water, and dried in air at 105° C. for 2 hours, to give a white powder which analysed as 20.6% Sn by weight.

### EXAMPLE 15

40 ml of a colloidal suspension of tin(IV) oxide, prepared as in Example 1, were added to 5 g of silica in a 50 ml screw-capped tube. The pH of the resulting suspension was adjusted from 10.0 to 4.0 using dilute hydrochloric acid and the resulting product was separated by centrifugation, washed with distilled water, and dried in air at 105° C. for 2 hours, to give a white powder which analysed as 21.3% Sn by weight.

### EXAMPLE 16

40 ml of a colloidal suspension of tin(IV) oxide, prepared as in Example 1, were added to 5 g of sodium bentonite in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 17.8% Sn by weight.

### EXAMPLE 17

40 ml of a colloidal suspension of tin(IV) oxide, prepared as in Example 1, were added to 5 g of a proprietary nanoclay, Cloisite 30B (ex-Southern Clay Products Inc), in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 4.7% Sn by weight.

### EXAMPLE 18

40 ml of a colloidal suspension of tin(IV) borate, prepared as in Example 6, were added to 5 g of sodium bentonite in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 10.6% Sn and 1.6% B by weight.

### EXAMPLE 19

40 ml of a colloidal suspension of tin(IV) phosphate, prepared as in Example 4, were added to 5 g of sodium bentonite in a 50 ml screw-capped tube. The tube was agitated on a mechanical shaker for 3 hours and the resulting product was separated by centrifugation, washed with distilled water, and dried in air at 105° C. for 2 hours, to give a white powder which analysed as 15.4% Sn and 5.7% P by weight.

### EXAMPLE 20

The fire-retardant properties of the novel nano-particulate coated products were investigated as follows. The powdered product described in Example 3, having a composition equivalent to ca. 25% tin(IV) oxide:75% magnesium hydroxide by weight, was incorporated into a halogen-free ethylene-vinyl acetate (EVA) cable formulation by compounding on a 16 mm twin-screw extruder operating at 155-165° C., followed by compression moulding at a pressure of 20 tonnes and a temperature of 160° C. for 15 mins.

In order to assess whether the novel coated products exhibit any significant improvements in fire-retardant performance over conventional additives, EVA compositions containing Mg(OH)₂ itself or a simple mixture of SnO₂+Mg(OH)₂, in equivalent level amounts to those present in the coated product, were also prepared.

Flame-retardant and smoke-suppressant properties of the EVA samples were assessed using two standard fire test techniques. The Limiting Oxygen Index (LOI) test is an indicator of ease of combustion in an oxygen-nitrogen atmosphere through downward burning of a vertically mounted specimen. The test method is generally reproducible to an accuracy of ±0.5%, giving a useful comparison of the relative flammability of different materials. Higher LOI values represent better flame retardancy. Measurements were undertaken in accordance with BS 2782 (Part 1, Method 141).

The Cone Calorimeter uses a truncated conical heater element to irradiate test specimens at heat fluxes from 10-100 kW/m², thereby simulating a range of fire intensities. The technique has been shown to provide data that correlate well with those from full-scale fire tests. Cone Calorimeter tests were carried out in duplicate, using a 50 kW/m² incident heat flux, following procedures recommended in BS 476 (Part 15). The technique provides detailed information about ignition behaviour, heat release and smoke evolution during sustained combustion and parameters reported in this work are defined below:

Peak Rate of Heat Release, Peak RHR (kW/m²)—taken as the peak value of the heat release rate vs. time curve, and considered to be the variable that best expresses the maximum intensity of a fire, indicating the rate and extent of fire spread.

Fire Performance Index, FPI (m²·s/kW)— defined as the ratio of ignition time to Peak RHR, this parameter relates to time to flashover (or the time available for escape) in a full-scale fire situation. Higher values of FPI represent improved fire safety.

Smoke Parameter, SP (MW/kg)—defined as the product of the measured specific extinction area and Peak RHR, this parameter is indicative of the amount of smoke generated in a full-scale fire situation.

Fire test results for the EVA samples are given in Table 1.

| Sample* | LOI | Peak RHR | FPI | SP |
|---|---|---|---|---|
| Control - no additives | 20.2 | 1404 | 0.04 | 665 |
| 100 phr Mg (OH)₂ | 23.2 | 538 | 0.13 | 148 |
| 100 phr SnO₂ − coated | 25.3 | 340 | 0.16 | 141 |
| Mg (OH)₂ | | | | |
| 100 phr SnO₂ + Mg (OH)₂ | 23.4 | 576 | 0.10 | 219 |
| mixture | | | | |

*phr = parts per hundred of resin.

Significant improvements in flame retardancy and smoke suppression are given by the nano-particulate SnO₂-coated Mg(OH)₂ compared to equivalent levels of either Mg(OH)₂ alone, or a simple mixture of SnO₂ with Mg(OH)₂. This increased activity is believed to arise from the vastly superior dispersion of the active tin species in the composition containing the coated product produced in Example 3.

1. A process for the preparation of an inorganic material which comprises a particulate inorganic filler selected from alumina trihydrate, magnesium hydroxide, calcium carbonate, magnesium carbonate, zinc borate, silica, talc, anhydrous alumina, sodium bentonite, nanoclays, magnesium calcium carbonate, hydrated basic magnesium carbonate, or mixtures thereof coated with nano-particulate tin compounds, which process comprises the steps of:
(i) forming a slurry of the said particulate inorganic filler in an aqueous colloidal suspension of a tin compound, whereby the tin compound is directly precipitated from the colloidal suspension onto the surface of the said filler,
(ii) separating the said inorganic filler from the colloidal suspension, either with or without the adjustment of the pH of the slurry prior to separation,
(iii) optionally, heating the filler coated with the nano-particulate tin compound, in order to convert the hydrated tin compound to an anhydrous form.

2. A process as claimed in claim 1 wherein in step (i) an acid or a soluble metal salt is added to the slurry.

3. A process as claimed in claim 2 wherein the acid is phosphoric acid, boric acid, tartaric acid or citric acid.

4. A process as claimed in claim 2 wherein in step (i) the soluble metal salt is a salt of zinc, iron, cobalt, nickel or copper.

5. A process as claimed in claim 1 wherein in step (iii) the filler coated with the nano-particulate tin compound is heated to a temperature in the range of from 150 to 400° C.

6. A process as claimed in claim 1 wherein the said filler particles have an average particle size in the range of from 0.01 to 100 micrometres.

7. A process as claimed in claim 6 wherein the said filler particles have an average size in the range of from 0.1 to 20 micrometres.

8. A fire-retardant material comprising a particulate inorganic filler coated with a nano-particulate tin compound in an amount of from 1 to 100% by weight, based on the weight of inorganic filler.

9. A fire-retardant material as claimed in claim 8 in which the nano-particulate tin compound is present in an amount of from 2 to 50% by weight, based on the weight of inorganic filler.

10. A fire-retardant material as claimed in claim 8 obtained by the process as claimed in claim 1.

11. A polymer composition comprising a polymeric material and a fire-retardant material as claimed in claim 8.

12. A polymer composition as claimed in claim 11 which comprises from 5 to 400% by weight, based on the polymeric material, of the fire-retardant material.

13. A polymer composition as claimed in claim 12 which comprises from 20 to 200% by weight, based on the polymeric material, of the fire-retardant material.
